(19) United States
(12) Patent Application Publication
(10) Pub. No.: US 2020/0410508 A1
(43) Pub. Date: Dec. 31, 2020

(54) WORKFLOW TRANSACTIONS

(71) Applicant: Hewlett-Packard Development Company, L.P., Spring, TX (US)

(72) Inventors: Joshua Serratelli Schiffman, Bristol (GB); Remy Husson, Bristol (GB); Helen Balinsky, Bristol (GB)

(73) Assignee: Hewlett-Packard Development Company, L.P., Spring, TX (US)

(21) Appl. No.: 16/975,414

(22) PCT Filed: Apr. 16, 2018
(86) PCT No.: PCT/US2018/027794

§ 371 Date: Aug. 25, 2020

(51) Int. Cl. G06Q 30/00; H04L 9/30; G06Q 10/10; G06Q 50/04

(52) U.S. Cl. CPC G06Q 30/018; G06Q 50/04; G06Q 10/103; H04L 9/30

(57) ABSTRACT

A method, in examples, comprises appending multiple workflow transactions to a distributed digital ledger, verifying a sequence of the multiple workflow transactions using verification criteria, generating a certification transaction attesting to the verified sequence of multiple workflow transactions according to a visibility policy, collating multiple certification transactions for respective sequences of workflow transactions, and generating a chained certification transaction.

### BACKGROUND

In manufacturing workflows, multiple stakeholders may be involved in the production or assembly of an end product. An independent auditor or verifier can be used to check that a party is in compliance with a set of criteria relating to the product's manufacture or assembly and may issue a certification to represent a statement of the product's compliance.

### BRIEF DESCRIPTION OF THE DRAWINGS

Various features of certain examples will be apparent from the detailed description which follows, taken in conjunction with the accompanying drawings, which together illustrate, by way of example only, a number of features, and wherein:

FIG. 1 is a schematic representation of a workflow process according to an example;

FIG. 2 is a flowchart of a method according to an example;

FIG. 3 is a schematic representation of a processor associated with a computer readable storage medium of a verification agent according to an example; and

FIG. 4 is a schematic representation of a processor associated with a computer readable storage medium of a summary agent according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Modern manufacturing processes often involve multiple stakeholders that should satisfy different sets of criteria specified by third parties such as regulatory bodies for example. In some examples, compliance with these criteria can be represented by a certification granted by a verifier. For example, some products carry a visible (or non-visible) certification or verification mark enabling a purchaser, owner or auditor for example, to verify that the product complies one or more criteria relating to the manufacture and/or assembly of the product. Criteria can include the use of certain components that may have a certain provenance, use of authorised assembly or manufacturing techniques, absence of specific materials in an end product and so on. Accordingly, multiple stakeholders may be involved in the production or assembly of an end product, and to certify that each party lives up to any contractually binding requirements, a verifier (e.g., an independent auditor) can be used to check that a party is in compliance with a set of criteria.

In the example of a complicated supply chain, an item may pass through many stakeholders each with different certification requirements. Efficiently representing the collection of certifications to the holder of the finished product is challenging due to the multitude of parties involved and the opacity of the verification process. Moreover, exposing the details of the process may reveal information about sensitive business agreements and violate privacy requirements.

Nevertheless, a party along the supply chain may wish to check that an item was handled by compliant parties. To do this, they may, for example, inspect the presence and validity of certifications for each stakeholder. However, in a sufficiently large supply chain, it may be difficult to represent this information in a single, convenient location. For example, a laptop may be comprised of numerous parts assembled in multiple locations and shipped through a global shipping network. Each component may be certified by relevant regulatory bodies, but verification of these certifications often requires looking up a serial number and contacting a regulatory office.

According to an example, steps in a supply chain can be represented as transactions in a distributed digital ledger (e.g., a Blockchain). As such, querying certifications associated with a product may be far more convenient. For example, one may take a reference to the final object (e.g., a laptop's serial number) and trace the steps through the supply chain back to its inception to find all relevant certifications associated with it.

According to an example, a product workflow, relating to a manufacturing or assembly process for the product, has an architecture. In the architecture, according to an example, multiple actors/stakeholders in the workflow have an identity represented by a public key pair and certified by a certificate authority (CA). An actor may be comprised of multiple entities, but all operate under the actors identity. In an example, ID_CA is the public key of an actor known by an ID stated by a CA. Whenever a transaction is inspected, the inspector can validate the identity against a certificate chain rooted in a trusted CA root certificate.

In an example, actors participate in a consortium that regulates and maintains a distributed digital ledger (such as a blockchain) for the workflow. The consortium can maintain an access control policy and mechanism for granting actors and auditors access to appropriate information.

Actions performed by an actor can be recorded as a transaction in a blockchain and signed by that actor. Rules of the workflow define a valid form for transactions and the business logic for which transactions should be accepted given the current state of the workflow. For example, an item may be transferred only after its holder has been authorized to do so. It is assumed that all operations relevant to the workflow and certification criteria are recorded in the blockchain.

In an example, Tx(ID_CA, Action, Policy) is a transaction performing some Action by actor ID_CA and visible to anyone satisfying a policy, “Policy”. Visibility can be controlled through a mechanism such as cryptography (e.g., Identity Based Cryptography) or access control that reveals parts of the transaction based on the Policy.

Reading and processing a transaction can be limited by a visibility access control mechanism or policy. This can be implemented through a reference monitor like entity (e.g., a server) or through a cryptographic mechanism like Identity Based Encryption. The policy authority can be used to issue credentials to the reader to enable access to protected data in the transaction. Credentials could be a decryption key or an access token given to the access control mechanism for example.

In an example, another way of providing limited visibility is to put the hash of a document (for example) in a transaction. Thus, only the participants possessing the document can verify it is the one present in the transaction. This is usually used with Merkle trees which also allow to reveal the content of leaf to a participant without revealing the rest of data. The hash of encrypted data can also be put in the transaction.

A verifier can issue a statement of compliance as a transaction. A certification can indicate that a set of criteria has been satisfied by a series of transactions in the blockchain. Trust in the verifier is equivalent to manually checking the transactions that satisfied the criteria.

A set of criteria can be specified by a third party that is trusted to create a set of criteria for validating some property. The verifier can validate that these criteria come from the appropriate entity by inspecting a certificate chain rooted in some trusted CA root certificate. A verifier may make the criteria and their identity pubic but hide the specific transactions that satisfy the criteria.

In an example, Verify(<Tx_0, . . . , Tx_n>, Criteria) is a function that checks if a series of transactions satisfies a Criteria, and Tx(ID_CA, Verify(<Tx_0, . . . , Tx_n>, Criteria), Policy) is a certification transaction by a verifier ID_CA certifying that a list of transaction satisfies some Criteria. Visibility of the certification can be based on the Policy. A verifier may reveal details of the certification upon request.

In an example, a Verify function can be implemented inside the blockchain. For example, some blockchains allow the use of complex enforcing mechanisms when a transaction is submitted. For example, a following transaction would only be allowed if the Verify function is successful at a specific point within the workflow. Then the blockchain would block the progression if certain conditions are not met. The very progress of the workflow would then indicate that the chained certification is valid. This can be limited by the access control and privacy mechanisms.

In an example, summary agents can be used to generate a chained certificate which is a collection of satisfied criteria and references to the transactions that prove the certification. The chained certificate can also be entered into the blockchain as a transaction. In an example, a summary agent could be the blockchain itself, such that the the chained certificate would automatically be inserted into the blockchain state when the right conditions are met. A combination of blockchain enforcement and external agents can be used depending on the use case.

In an example, Chain(<(Ref(Tx_0), Criteria_0), . . . (Ref(Tx_n), Criteria_n)>) can be a collection of references to certification transactions and the criteria that are claimed to be satisfied by the certification. Tx(ID_CA, Chain(<(Ref(Tx_0), Criteria_0), . . . (Ref(Tx_n), Criteria_n), Policy> can be a chained certification transaction signed by ID_CA with visibility specified by Policy.

A summary agent can also generate a physically representable chained certificate (or instructions to do so) that can be applied to a final product. This can be a OR code of the URL to the blockchain transaction for example.

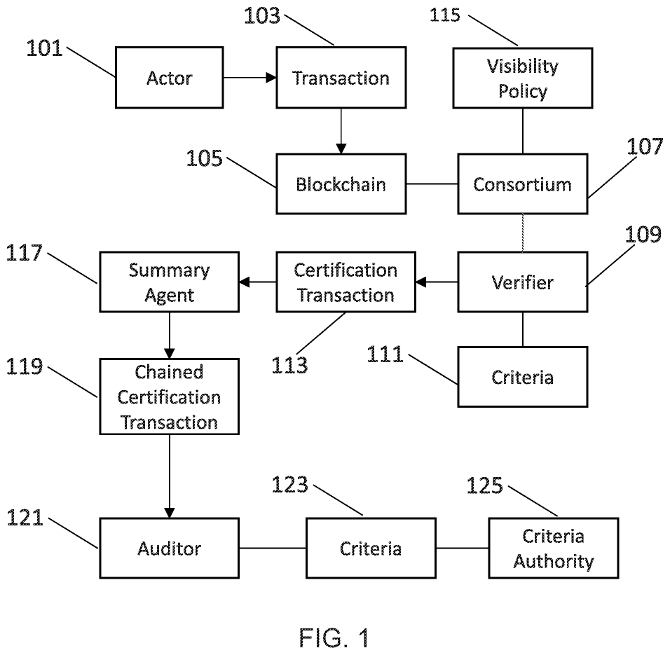

FIG. 1 is a schematic representation of a workflow process according to an example. Actors 101 in the workflow issue transactions 103 during their operation. Each transaction 103 is submitted to the blockchain 105 maintained by a consortium 107. Verifiers 109 within the consortium 107 (as noted above, a verifier may be the blockchain enforcing mechanisms) observe the transactions and check them against their verification criteria 111. When a verifier finds that their criteria has been satisfied by a specific sequence of transactions, the verifier issues a certification transaction 113 for that sequence and criteria under a predetermined visibility policy 115.

According to an example, at specified points in the workflow, Summary Agents 117 collect certification transactions for a product and produce a chained certification transaction 119. A representation of the chain certification 119 may be physically applied to the manufactured object. An example is a OR code of the transaction or a URL a user can follow to obtain the transaction. When an end user or auditor 121 wishes to inspect the chained certification 119, they inspect at the list of satisfied criteria. The user will have their own list of criteria 123, provided by a criteria authority 125, with which to compare against the chained certification list. If the chained certification list contains all of the user's required criteria, then they can be satisfied that the object was produced by or assembled in a supply chain with the required certifications. If the transaction is protected due to a policy restriction; the user can request access through a policy authority. In an example, this authority could be referenced by the transaction to make lookup easier.

Accordingly, a simplified representation and validation of multiple certifications over a complicated manufacturing supply chain can be provided. Flexibility is provided by integrating multiple parties' criteria in a blockchain system of record, which also supports privacy requirements through the use of a policy-based visibility mechanism. The process described above can be applied to various supply chain scenarios including, for example, 3D printing, traditional manufacturing, and assembly logistics.

An authority can therefore audit a certification that can be applied to a product. The certification embodies a number of certificates that are themselves generated from respective sequences of verified transactions appended to a blockchain for a product workflow. For example, at each stage of an assembly process a sequence of transactions can represent the application of certain workflow steps or components in a product. The sequences are verified against a policy, and (if satisfied) a certificate can be issued attesting to the validity of the sequence. A collection of such certificates can be chained and appended to the blockchain (and product) to enable audit.

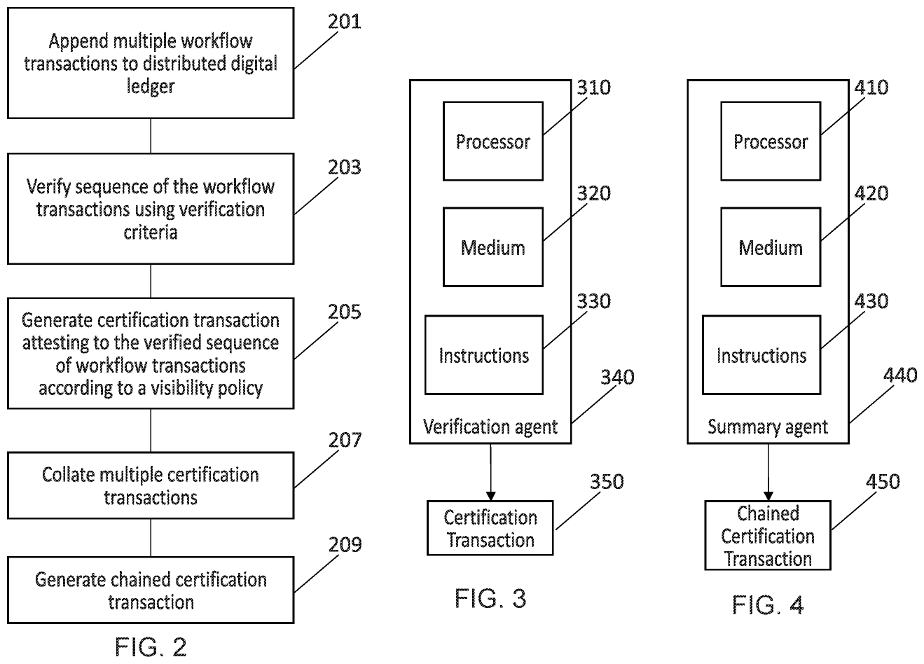

FIG. 2 is a flowchart of a method according to an example. In a workflow for an object product, which workflow can relate to a manufacturing, rendering or assembly process for example, multiple workflow transactions are appended to a distributed digital ledger (block 201). As noted above, each transaction can be an action performed by an actor, and may be signed by the actor in question using a cryptographic key. In an example, an action, resulting in a transaction, could be addition of a certain component or layer into a product as part of an assembly or rendering process. Another example could be a transaction representing use of an approved material, assembly or production line and so on. In an example, the distributed digital ledger is a blockchain.

In block 203, a sequence of workflow transactions are verified using verification criteria. For example, as noted above, a verifier within the consortium can observe the transactions and check them against their verification criteria. So, for example, as transactions are appended to the blockchain, the verifier can check each transaction against a set of predetermined criteria in order to determine whether a sequence or set of transaction satisfies the criteria. The sequence or set may or may not be contiguous.

In block 205, when the verifier finds that their criteria has been satisfied by a specific sequence of transactions, the verifier can generate a certification transaction attesting to the verified sequence of workflow transactions according to a visibility policy that can be used to regulate access to the transaction and/or certification transaction.

In block 207, multiple certification transactions can be collated for respective sequences of workflow transactions, and in block 209 a chained certification transaction for the multiple certification transaction can be generated.

In an example, certified transactions can be visible to anyone that had access to the blockchain that the certificate references. Access to that blockchain can be regulated by an access control service that sits between users and the nodes that participate in the blockchain.

In another example (out-of-band access) transaction data can be cryptographically represented in the certificate but inaccessible to the average user (e.g., hash or encryption of the transactions). Parties that want to view the transactions can get access to the cryptographic material to see (decryption keys) or verify (original transactional data) the values stored in the certificate. This material can be delivered to the requesting party via a service that is not part of the blockchain if they are permitted to view it.

That is, transactions relating to actions performed in a workflow for a product or object can be recorded in a blockchain. A specific criterion associated with the workflow can be satisfied by a sequence of the transactions, verified and recorded in the form a certification transaction, which itself may be appended to the blockchain. Multiple such certification transactions, each relating to respective different sequences of transactions for a product or object, can be collated to form a chained certification transaction that can be used to enable audit.

Examples in the present disclosure can be provided as methods, systems or machine-readable instructions. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

FIG. 3 shows an example of a processor 310 associated with a computer readable storage medium 320 of a verification agent 340 according to an example. The computer readable storage medium 320 comprises computer readable instructions 330 which are executable by the processor 310. The instructions 330 comprise instructions to verify a sequence of workflow transactions using verification criteria, and instructions to generate a certification transaction 350 attesting to the verified sequence of workflow transactions according to a visibility policy.

FIG. 4 shows an example of a processor 410 associated with a computer readable storage medium 420 of a summary agent 440 according to an example. The computer readable storage medium 420 comprises computer readable instructions 430 which are executable by the processor 410. The instructions 430 comprise instructions to collate multiple certification transactions, and instructions to generate chained certification transaction 350.

Similar structures to those of FIGS. 3 and 4 can be used in order to append transactions to a blockchain, for example.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
appending multiple workflow transactions to a distributed digital ledger;
verifying a sequence of the multiple workflow transactions using verification criteria;
generating a certification transaction attesting to the verified sequence of multiple workflow transactions according to a visibility policy;
collating multiple certification transactions for respective sequences of workflow transactions; and
generating a chained certification transaction.

2. A method as claimed in claim 1; wherein a transaction represents an action performed in the workflow for a product or object.

3. A method as claimed in claim 1, wherein the sequence of the multiple workflow transactions are non-contiguous transactions in the distributed digital ledger.

4. A method as claimed in claim 1, wherein the chained certification transaction is a tuple comprising multiple certification transactions and respective associated criteria that are satisfied by the certification transactions.

5. A method as claimed in claim 1, further comprising signing the chained certification transaction with a public cryptographic key.

6. A method as claimed in claim 5, further comprising providing a visibility for the signed chained certification transaction according to a visibility policy.

7. A method as claimed in claim 1, further comprising:
applying a representation of the chained certification transaction to an object or product.

8. A method as claimed in claim 1, further comprising:
comparing the chained certification transaction against a predetermined set of criteria to determine whether an object or product has been produced by or assembled in a supply chain with expected certifications.

9. A method as claimed in claim 8, further comprising:
providing access to the chained certification transaction.

10. A non-transitory machine-readable storage medium encoded with instructions executable by a processor for generating a chained certification transaction in a distributed digital ledger, the machine-readable storage medium comprising instructions to:
validate, using a verification measure, a sequence of multiple transactions appended to the distributed digital ledger relating to an object workflow:
attest to the authenticity of the sequence of multiple transactions using a certification transaction generated according to a visibility policy; and
generate a chained certification transaction from multiple certification transactions for respective sequences of workflow transactions.

11. A non-transitory machine-readable storage medium as claimed in claim 7, further encoded with instructions to:
sign the chained certification transaction with a public cryptographic key.

12. A non-transitory machine-readable storage medium as claimed in claim 7, further encoded with instructions to:
append the chained certification transaction to the distributed digital ledger.

13. A non-transitory machine-readable storage medium as claimed in claim 7, further encoded with instructions to:
link an action performed in a workflow for a product or object to a transaction for the product or object.

14. A non-transitory machine-readable storage medium as claimed in claim 7, further encoded with instructions to:
compare the chained certification transaction against a predetermined set of criteria; and
determine whether an object or product has been produced by or assembled in a supply chain with expected certifications.

15. A non-transitory machine-readable storage medium as claimed in claim 7, further encoded with instructions to:
enable access to the chained certification transaction.
